(19) United States
(12) Patent Application Publication
(10) Pub. No.: US 2025/0289486 A1
(43) Pub. Date: Sep. 18, 2025

(54) RF-POWERED RAILWAY MONITORING SYSTEM AND METHOD USING THE SAME

(71) Applicant: The Hong Kong University of Science and Technology, Hong Kong (CN)

(72) Inventors: Zhengbao YANG, Hong Kong (CN); Yuanyi WANG, Hong Kong (CN)

(21) Appl. No.: 19/073,030

(22) Filed: Mar. 7, 2025

Related U.S. Application Data
(60) Provisional application No. 63/566,401, filed on Mar. 18, 2024.

(51) Int. Cl. B61L 23/04; H02J 50/20

(52) U.S. Cl. CPC B61L 23/042; H02J 50/20

(57) ABSTRACT

A maintenance-free, automatic track monitoring system has been developed to monitor rail tracks and detect potential hazards that could pose safety concerns or lead to derailments. The track monitoring system operates during normal railway service without disruptions to train operations. The track monitoring system includes an on-train device and wayside battery-free sensing tags (WBSTs). The on-train device utilizes radio frequency (RF) energy to wirelessly charge WBSTs. As the train passes, the WBSTs collect data, such as track vibration and temperature, which is then transmitted back to the on-train device. The proposed track monitoring system enables early hazard detection and provides valuable data for further analysis and real-time alerts, enhancing railway safety and maintenance efficiency.

### TECHNICAL FIELD

The present invention relates to railway monitoring and RF energy harvesting technologies. More specifically, it involves a battery-free, RF-powered system designed for real-time track condition monitoring.

### BACKGROUND

Since the first industrial revolution, the astronomical growth of trade and population has driven a significant expansion of the global railway network. The maintenance of such a wide railway network is challenging in terms of timeliness, cost, and efficiency. At present, the detection work of the rail is mainly done by special rail inspection vehicles that can detect various parameters of rails. However, this rail inspection vehicle needs to occupy the rails for a long time, which will reduce the efficiency of railway operation and increase operating costs.

In order to avoid accidents, artificial intelligence (AI) prediction models based on machine learning and reinforcement learning have been proposed, but these models require a large amount of measurement data and cannot replace real-time monitoring results. Wireless sensor nodes combining Internet of Things (IoT) provides a solution for large-scale infrastructure monitoring. Existing self-powered sensors have a narrow operating bandwidth, making it difficult to design a system suitable for all working conditions. Wireless power transfer methods, such as inductive and magnetic coupling, are widely used for short-distance applications like charging electronic devices but are not suitable for high-speed moving trains.

One of the related works discloses a vehicle mounted monitoring system for monitoring rail track for detecting and generating alerts for certain hazards to the operation of trains that may cause various safety concerns and even derailment. The monitoring system is set in passenger or freight trains. The imaging module on the vehicle captures video images of the track as the train moves. The captured video images are automatically processed in a computer on board the train to determine if there are any irregularities on the track. However, this method will limit the maximum speed of train operation and reduce the operating efficiency of the railway system.

One of the related works discloses a method for sensing, which includes utilizing sensing devices and data wireless transmission devices for monitoring train components such as bogies. This device can record changes in the same part over time to help component fault, condition and predict failure times. However, this method can only monitor the status of the train and cannot replace manual inspection of the rails.

One related report, “Health Monitoring of Urban Rail Corrugation by Wireless Rechargeable Sensor Nodes”, introduces a system using wireless rechargeable sensor nodes for urban rail corrugation health monitoring. The proposed system includes a local energy generator based on the electromagnetic induction principle. Moreover, it builds a vehicle-track model to investigate the dynamic response of a railway track with and without rail corrugation. Nonlinear wheel-track contact forces, based on Hertzian elastic contact theory, together with a fast explicit time-integration method, are utilized to calculate the dynamic responses of a vehicle-track coupled system. However, the sensor nodes operate only at resonance, meaning maximum energy collection is possible only under specific conditions. Additionally, the large size of the sensor nodes limits their installation options.

Another related report, “Self-Powered Wireless Smart Sensor Based on Maglev Porous Nanogenerator for Train Monitoring Systems”, demonstrates a self-powered wireless smart sensor, powered by train-induced vibration energy via a maglev porous nanogenerator (MPNG). The integrated MPNG includes a triboelectric nanogenerator (TENG), which delivers a peak power density of 0.34 mW/g at 50 MΩ, and an electromagnetic generator (EMG), which delivers a peak power density of 0.12 mW/g at 700Ω. However, the sensor still faces the limitation of operating under a single working condition. Moreover, the sensing system primarily focuses on bogie health monitoring rather than railway track condition monitoring.

Another related report, “A High-Power, Robust Piezoelectric Energy Harvester for Wireless Sensor Networks in Railway Applications”, presents a piezoelectric stack energy harvester designed for railway track detection. A maximum power of 511 mW and an average power of 24.5 mW are achieved at a harmonic excitation of 21 Hz and 0.7 g RMS (Root Mean Square), while a maximum power of 568 mW and an average power of 7.3 mW are generated under a measured railway track vibration signal. However, the manufacturing process of the piezoelectric stack is complex, and its high cost makes it unsuitable for railway monitoring systems that require a large number of sensor nodes.

Another related report, “Advanced Monitoring Systems Based on Battery-Less Asset Tracking Modules Energized through RF Wireless Power Transfer”, introduces a system based on RF Wireless Power Transfer (WPT) to power a battery-less Bluetooth Low Energy (BLE) tag for asset tracking. The battery-less tags, powered by RF energy, can identify and monitor asset speeds. However, the energy transfer efficiency of this system is low, making it unsuitable for high-speed trains.

Therefore, there is a need for a battery-free, RF-powered railway monitoring system that enables real-time track condition monitoring and reduces maintenance costs.

### SUMMARY OF INVENTION

It is an objective of the present invention to provide a system and a method to address the aforementioned shortcomings and unmet needs in the state of the art.

In the present invention, a radio frequency-powered (RF-powered) railway monitoring system is presented, incorporating Wayside Battery-free Sensing Tags (WBSTs) to address the limitations of existing railway monitoring systems. The developed passive wireless sensor harvests energy from the on-train RF power source to measure rail acceleration and temperature in real time, eliminating the need for battery replacement and enhancing railway safety. Unlike traditional monitoring systems, the WBST achieves a battery-free operation, compact size, minimal impact on train operation, stable energy transmission, and real-time data collection. The detection system can be optimized based on usage conditions and applied to other wireless monitoring scenarios. In conclusion, the proposed rf-powered railway monitoring system offers advantages in maintenance-free operation, high energy transfer efficiency, and real-time monitoring.

In accordance with an aspect of the present invention, a system for battery-free and RF-powered railway monitoring is provided. The system includes a plurality of on-train power, a plurality of WBSTs, at least one reader, a base station, a server, and a control center. The on-train power generators are positioned on a train. The WBSTs are fixedly mounted on rails along a track. The train operates along the track following a predefined route. The on-train power generators are configured to transmit RF energy to the WBSTs for power supply wirelessly when the train passes, such that the WBSTs have no batteries and are powered solely by RF energy emitted by the on-train power generators. The WBSTs are configured to collect track parameters of the rails along the track to continuously monitor one or more of the track parameters as the train passes. The at least one reader is positioned at the train and is configured to receive data transmitted from the WBSTs so as to obtain track conditions of the rails beneath the moving train. The reader processes the data and determines whether the track conditions comply with predefined safety thresholds, thereby assessing whether any one or any section of the rails along the track is damaged. If an anomaly is detected, the on-train reader is activated to emit signals or send data. The base station acts as an intermediary communication hub and receives track data from the on-train reader. The server stores and organizes the track data from the base station for long-term analysis and railway condition monitoring. The control center retrieves data from the server and performs real-time analysis of railway track conditions. If an abnormality is detected, the control center triggers alerts and notifies an external system.

By the configuration above, there are at least three novel features provided by the present invention, summarized as follows:
(1) The RF-powered railway monitoring system exhibits outstanding maintenance efficiency. The WBSTs do not contain batteries and require no cable connections, eliminating the need for human maintenance throughout their entire lifecycle.
(2) The RF-powered railway monitoring system can collect a large amount of real-time data on the rails as trains pass by. This data enables accurate and timely risk assessment. Additionally, by analyzing data trends, the system can estimate the lifespan of the rails and optimize maintenance plans accordingly.
(3) The RF-powered railway monitoring system offers high scalability and can be adapted for other infrastructure monitoring applications. Its circuit design and sensor configuration can be optimized to meet the specific requirements of different monitoring scenarios.

### BRIEF DESCRIPTION OF DRAWINGS

Embodiments of the invention are described in more details hereinafter with reference to the drawings, in which:

FIG. 1 shows a sensing scheme of a battery-free and RF-powered railway monitoring system according to some embodiments of the present invention;

FIG. 2 shows a schematic block diagram illustrating the architecture in which the on-train reader interacts with other components for further processing according to some embodiments of the present invention;

FIG. 3 shows a block diagram of energy flow and communication according to some embodiments of the present invention;

FIG. 4A shows a schematic diagram of a WBMT system architecture according to some embodiments of the present invention;

FIG. 4B shows modules connected via pin headers, providing a detailed view of an embedded system, a power management unit (PMU), an energy harvesting (EH) circuit, and a communication antenna;

FIG. 4C illustrates the measured power consumption of the WBMT;

FIGS. 5A, 5B, and 5C illustrate a design scheme of a mini-branch-line coupler (mini-BLC) according to some embodiments of the present disclosure;

FIGS. 6A, 6B, and 6C compare the performance of the conventional and the proposed mini-BLC; and

FIGS. 7A, 7B, 7C, 7D present comparison graphs between the proposed energy harvesting scheme and the conventional scheme.

### DETAILED DESCRIPTION OF THE INVENTION

In the following description, radio frequency-powered (RF-powered) railway monitoring systems and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present invention, a railway monitoring system is provided, featuring a battery-free and RF-powered railway monitoring approach. The proposed railway monitoring system utilizes RF wireless power transfer to enhance the safety of the railway system.

Briefly, the battery-free and RF-powered railway monitoring system includes on-train energy generators, on-train readers, and wayside battery-free sensing tags (WBSTs). The WBSTs are discretely mounted on the rails along the track and are configured to collect track condition data as a train passes. The on-train energy generators generate radio frequency energy (RF energy) to power the WBSTs. The on-train readers receive the track condition data transmitted by the WBSTs, determine whether the data exceeds the safety threshold, and forward it to a control center for further analysis.

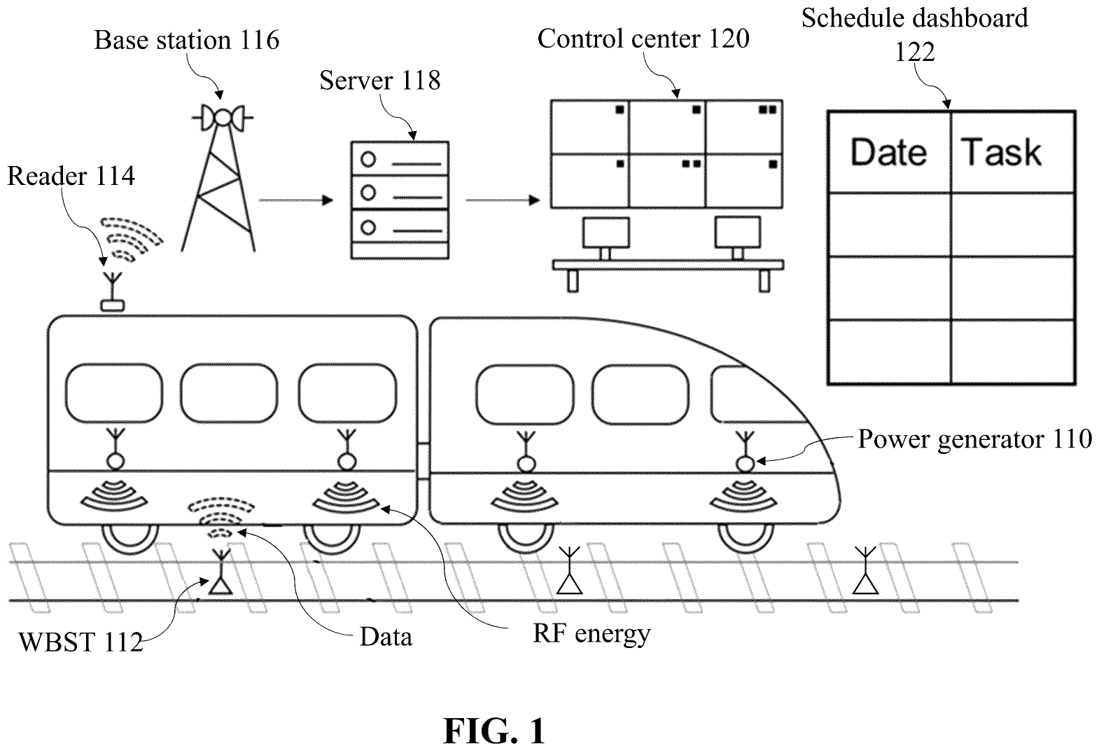

Specifically, FIG. 1 shows a sensing scheme of a battery-free and RF-powered railway monitoring system 100 according to some embodiments of the present invention. This diagram illustrates the working principle of the battery-free and RF-powered railway monitoring system 100, which utilizes WBSTs to monitor track conditions. The battery-free and RF-powered railway monitoring system 100 is applied to a train 102 traveling on rails 104 along a track, transmitting collected data through an onboard wireless communication unit to a control center, enabling battery-free, automated railway health monitoring and maintenance planning.

The battery-free and RF-powered railway monitoring system 100 includes on-train power generators 110, WBSTs 112, one or more on-train reader 114, a base station 116, a server 118, a control center 120, and a schedule dashboard 122.

The on-train power generators 110 are positioned at the bottom of the train 102 and the on-train reader 114 is positioned at the top of the train 102. The on-train power generators 110 and the on-train reader 114 are arranged according to safety standards. Although there is one on-train reader 114 illustrated in FIG. 1, a plurality of on-train readers may be mounted on different carriages of the train 102 respectively. The WBSTs 112 are positioned along the track. In various embodiments, the WBSTs 112 are fixedly mounted on rails 104 along the train's route.

The on-train power generators 110 are configured to transmit RF energy to the WBSTs 112 for power supply. In this regard, RF energy is wirelessly transferred to the WBSTs 112 from the on-train power generators 110 when the train 102 passes, providing the necessary power for the operation of the WBSTs 112 and eliminating the need for an internal battery attached to the rails 104. Accordingly, the WBSTs 112 have no batteries and can only be powered by RF energy emitted by the on-train power generators 110. The on-train power generators 110 attached to the train 102 can continuously charge the WBSTs 112 while the train is in motion.

As such, the on-train power generators 110 function as on-train RF energy transmitters, and the WBSTs 112 collect operational parameters of the rails 104 along the track as the train 102 passes. These operational parameters of the rails 104 can also be referred to as track parameters, reflecting track conditions. At least one of the track parameters is obtained from a stationary WBST 112. When multiple WBSTs 112 are arranged along the track, continuous monitoring of one or more track parameters is achieved by collecting track data from the WBSTs 112 deployed along the train's route. This arrangement is to allow the track parameters to be gathered within a desired monitoring section.

In some embodiments, the WBSTs 112 include sensors for collecting parameters such as vibration, temperature, and structural integrity measurements, or combinations thereof, thereby assessing the track conditions of the rails 104. For example, different sensors can be integrated into the WBSTs 112, including accelerometers, temperature sensors, and strain gauges. Furthermore, the data transmitted by the WBSTs 112 includes position information in addition to the track conditions of the rails 104. Once the WBSTs 112 receive RF energy from the on-train power generators 110, the WBSTs 112 are activated and wirelessly transmit the collected data (e.g., sensor measurement results and position information) to the on-train reader 114 for obtaining a structural status of the track. Accordingly, the data collected by the sensors of the WBSTs 112 is used to assess the structural status of the track.

In some embodiments, during monitoring operations, energy transmission between the on-train power generators 110 and the WBSTs 112 is achieved through RF transmission, while signal communication between the WBSTs 112 and the on-train reader 114 is also achieved through RF transmission. In some embodiments, the frequencies of the RF power used for energy transmission and the RF signal used for communication are different.

The on-train reader 114 is configured to receive data transmitted from the WBSTs 112 and is capable of obtaining the track conditions of the rails 104 along the track beneath the moving train 102, as measured by the WBSTs 112. In one embodiment, one or more on-train readers 114 are configured to receive one or more track parameters from stationary WBSTs 112 positioned along the route, enabling continuous measurement. The on-train reader 114 processes the data and determines whether the track conditions comply with predefined safety thresholds, thereby assessing whether any one or any section of the rails 104 along the track is damaged. If an anomaly is detected, the on-train reader 114 is activated to emit signals or send data; for example, the on-train reader 114 can transmit the data to the base station 116 for further processing.

In some embodiments, the on-train reader 114 is set with multiple predefined safety thresholds corresponding to various physical parameters, including vibration, temperature, and structural integrity measurements (e.g., strain). Upon receiving the data from the WBSTs 112, the on-train reader 114 performs an initial assessment by comparing the measured values against these predefined thresholds. If any of the monitored parameters exceed the acceptable limits, indicating a potential track anomaly, the on-train reader 114 flags the issue and transmits the data to the base station 116 for further processing and in-depth analysis.

To effectively utilize the WBSTs 112 for physical measurements in railway track damage monitoring, different placement rules for the WBSTs 112 along the track can be adopted to optimize monitoring accuracy and efficiency. For example, curvature radius, train speed variations, and environmental factors.

In embodiments involving placement based on track curvature, in curved sections of the track, the density of the WBSTs 112 is adjusted based on the curvature radius. For sharp curves with a smaller radius, a higher density of the WBSTs 112 is required to collect structural integrity data, including track deformation, stress distribution, and vibration variations caused by train movement. Since the rails 104 experience greater lateral forces and stress concentrations in these sections, increased placement density can help that specific points in curved sections are closely monitored for potential anomalies. Conversely, in gentler curves with a larger radius, where the structural stress and dynamic impact on the rails 104 are lower, a lower density of WBSTs 112 per unit length is sufficient to maintain effective monitoring coverage.

In embodiments involving placement based on train speed variation, the number of the WBSTs 112 per unit length also varies depending on the expected speed of the train 102 in different track sections. In urban areas or sections with dense surrounding buildings, where train speeds are lower, the WBSTs 112 can be spaced farther apart, as the reduced speed results in less stress and fewer abrupt dynamic forces acting on rails 104. However, in high-speed sections or unpopulated areas, where trains operate at significantly higher speeds, the WBSTs 112 density is increased to provide more frequent real-time monitoring. The higher placement density ensures better tracking of track integrity, temperature variations, and potential anomalies-factors that become more pronounced at higher train speeds due to greater dynamic forces acting directly on rails 104.

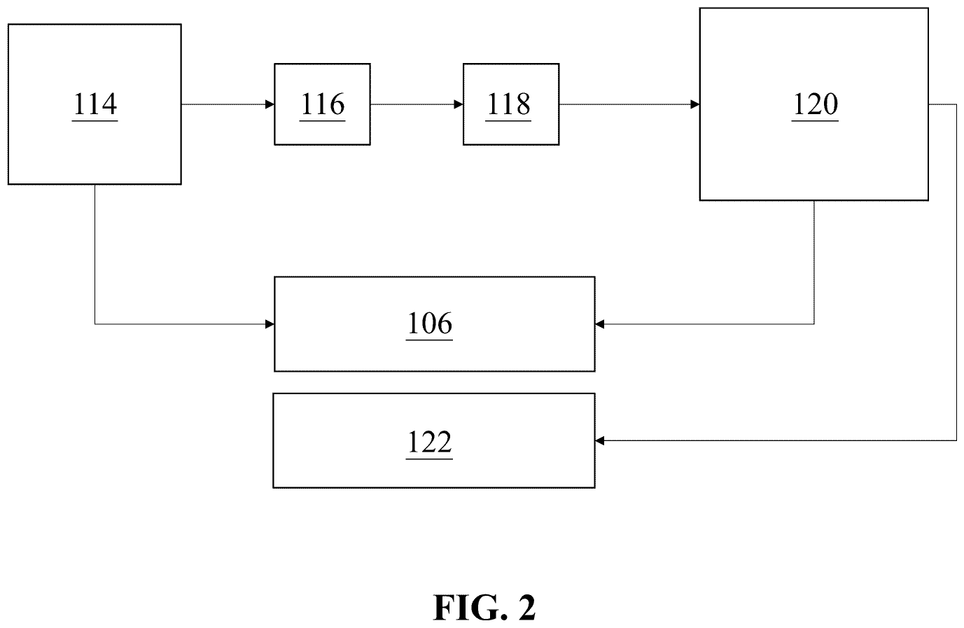

FIG. 2 shows a schematic block diagram illustrating the architecture in which the on-train reader 114 interacts with other components for further processing according to some embodiments of the present invention. As shown in FIG. 1 and FIG. 2, the on-train reader 114 is in communication with the base station 116; the base station 116 is in communication with the server 118; the server 118 is in communication with the control center 120; and the control center 120 is in communication with the schedule dashboard 122. Moreover, the train 102 includes a monitor 106 in communication with the on-train reader 114 and the control center 120 for displaying the operating status of the railway track in real-time.

The base station 116 acts as an intermediary communication hub, transmitting the received track data from the on-train reader 114 to the server 118. The server 118 stores and organizes the data for long-term analysis and railway condition monitoring. The control center 120 retrieves data from the server 118 and performs real-time analysis of railway track conditions. If abnormalities such as loose bolts, high-temperature deformations, or rail cracks are detected, the control center 120 can trigger alerts and notify maintenance personnel for necessary interventions. Additionally, the control center 120 generates maintenance plans, which are displayed on the schedule dashboard 122, utilizing data collected from the WBSTs 112. Based on long-term trend analysis, it helps optimize maintenance schedules, reduce operational downtime, and enhance railway safety.

During the processing, the on-train reader 114 can perform an initial assessment of track conditions based on data received from WBSTs 112. The train 102 is equipped with at least one on-train reader 114 to obtain one or more track parameters through discrete examinations, providing insights into the health of the railway system. The track parameters help detect potential issues such as broken tracks, deformed rails, or loose rails, thereby reducing the probability of derailment. As such, the on-train reader 114 can assess the track parameters to determine whether any section of the track in the rails 104 is damaged.

In response to detected damage, the on-train readers 114 are further configured to work with the control center 120 to manage the railway system, enabling a responsive assessment of damage detected in one or more sections of the rails 104. The assessment is conducted to confirm or quantify the extent of the sensed damage. The on-train reader 114 can flag the damaged section of the rails 104 and continuously monitor it, maintaining an ongoing evaluation process when the damage is confirmed or further quantified.

When the on-train reader 114 receives data exceeding predefined safety thresholds, an alert is immediately sent to both the monitor 106 on the train 102 and the control center 120, allowing for a prompt response to potential issues. For example, the train driver can monitor the real-time status of the rails 104 and take necessary precautions if an anomaly is detected. Meanwhile, the control center 120 processes the detected data, using it as a basis for planning maintenance schedules and optimizing track repair strategies.

Moreover, the on-train reader 114 is further configured to receive track parameters as geographically and temporally discrete information. Continuous monitoring of the track is conducted between multiple discrete examinations to provide comprehensive condition assessments. These examinations occur at different, non-overlapping time periods or locations, ensuring that both localized and long-term structural changes in the rails are accurately tracked. The continual monitoring process allows for a responsive system in which any detected damage is confirmed and quantified, thereby enhancing railway safety and operational efficiency.

As described above, what the on-train reader 114 performs is an initial assessment. For example, the on-train reader 114 is capable of automatically processing track operation data by comparing the captured data against predefined safety thresholds. If the captured data significantly exceeds the predefined threshold, the on-train reader 114 generates an alert signal to notify of potential traffic accidents if a parameter of the irregularity surpasses a safety standard threshold. The on-train reader 114 can issue a preliminary alert to the train 102, with the warning displayed on the monitor 106 for the train operator's awareness.

Simultaneously, the control center 120 conducts further analysis based on track parameters that exceed predefined safety thresholds. The analysis by the control center 120 aims to detect whether a potential traffic accident is present, including train derailments due to loose bolts, high-temperature deformation, or a combination thereof.

The control center 120 includes an anomalies trend database, which stores multiple parameter configurations associated with potential traffic accidents. These parameters are constructed by various physical measurements, including vibration, temperature, and structural integrity. By utilizing this database, the control center 120 can compare incoming data against high-risk parameter thresholds. If the detected values closely match these predefined high-risk conditions, it can indicate a potential abnormality in the rails 104. Moreover, since the multiple WBSTs 112 are deployed at the rails 104 along the track and are equipped with location information, the control center 120 can not only detect abnormalities but also determine the potential locations of these irregularities, achieving precise fault localization. In one embodiment, the control center 120 updates the anomalies trend database but does not emit a warning report if a significant change is detected for a certain irregularity from a previous run but does not exceed a safety limit.

The control center 120 includes a computing device capable of processing acquired data to perform physical parameter calculations. By analyzing the obtained parameters, the computing device can derive additional physical metrics, such as the relative position and relative motion of the track. This capability enables the system to assess track conditions from multiple perspectives. In one embodiment, the control center 120 compares at least one of the relative position and the relative motion of the track to a pre-determined safety standard threshold value. When the pre-determined safety standard threshold value is exceeded, the control center 120 flags the involved rails, indicating them are to be checked.

In one embodiment, upon detection for an irregularity on the track that adversely affects safety of the train, the control center 120 generates an alert signal to notify the presence of the irregularity if the detected irregularity meets a pre-selected criteria. For example, if an irregularity affecting train safety is detected due to track unevenness, the control center 120 will analyze the data to assess the degree of unevenness and determine its cause (e.g., whether it is due to temperature variations or rail displacement in rails 104). If the severity or nature of the unevenness meets the predefined alert conditions, the system will generate an alert signal to notify the presence of the irregularity, including its exact location.

The control center 120 processes both directly received physical parameters and those derived through a computing device. The control center 120 utilizes the computing device to detect threshold events occurring in at least one railcar of the train 102, such as when acceleration or temperature levels exceed a predefined limit. Upon detection, the computing device determines whether the threshold event is isolated to a single railcar or has also occurred in one or more additional railcars within a specified timeframe.

In one embodiment, the control center 120 is responsible for real-time monitoring and alert generation based on sensor data analysis. Near real-time visual alerts for malfunctioning track sections associated with at least one WBST 112 are displayed on the monitor 106 of the train 102 or other designated notification screens. For example, the control center 120 generates maintenance reminders and early warning notifications, which are displayed on the appropriate monitoring interfaces.

The control center 120 is responsible for generating maintenance plans based on comprehensive analysis of track conditions and historical anomaly data. For example, based on the analysis data, the control center 120 calculates the remaining lifespan of the rail infrastructure and formulates optimized maintenance plans. The plans are then transmitted to the schedule dashboard 122, where they are displayed for railway operators and maintenance teams. The maintenance plans include the scheduled time for maintenance operations and the specific maintenance tasks to be performed, such as track realignment, bolt tightening, or temperature-induced rail expansion checks.

Furthermore, the control center 120 can estimate potential deviations in train 102 speed by analyzing the time intervals of the WBSTs 112 charging and data transmission. For example, estimating train speed based on time delay analysis or detecting speed deviations and triggering alerts.

Regarding estimating train speed based on time delay analysis, to determine train speed, the control center 120 analyzes the timestamps of each WBST 112's activation and data transmission. The expected time difference between two consecutive WBSTs 112 transmissions is calculated based on the train's planned speed. If the actual transmission time intervals deviate from the expected values, it indicates that train 102 is moving either faster or slower than anticipated.

Regarding detecting speed deviations and triggering alerts, if the measured WBSTs 112 activation intervals suggest that the train is moving slower than expected, this could indicate unexpected delays, braking events, or operational inefficiencies. Conversely, if the train is moving faster than expected, it may suggest excessive acceleration, potential safety violations, or deviations from predefined operating schedules. When significant deviations are detected, the control center 120 can trigger alerts, enabling real-time speed adjustments and ensuring that the train adheres to operational safety protocols.

The proposed real-time scheme of the present invention enables maintenance personnel to promptly repair any abnormal rails, reducing the likelihood of accidents. Furthermore, managers can optimize the frequency of daily maintenance based on the collected data, minimizing the impact on the normal operation of the train system.

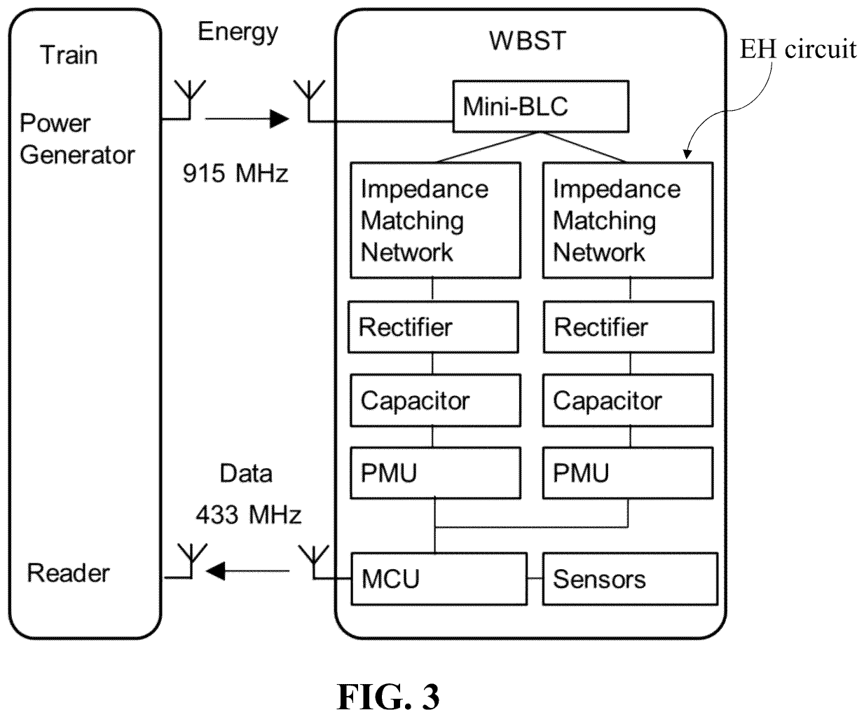

FIG. 3 shows a block diagram of energy flow and communication according to some embodiments of the present invention. The diagram illustrates the energy flow and communication architecture of the WBSTs. Each WBST is composed of a dual-band antenna, an energy harvesting circuit, and an embedded system. The dual-band antenna serves two purposes: (1) Receiving RF energy from the train-mounted power generator at 915 MHz to power the system; and (2) Transmitting sensor data wirelessly at 433 MHZ to the onboard reader. Both 915 MHz and 433 MHZ frequencies used in the system are license-free and commonly available.

The energy harvesting layout includes a branch-line coupler (Mini-BLC), two impedance matching networks, and two Dickson voltage multipliers. The Mini-BLC divides the harvested RF energy into two identical energy harvesting (EH) circuits to minimize return loss caused by impedance mismatch and to improve energy conversion efficiency. The rectifiers convert the received AC RF signal into DC power, while the capacitors store the energy for stable operation.

To keep continuous operation, a power management unit (PMU) regulates and stabilizes the voltage before supplying power to the embedded system, which includes an MCU (Microcontroller Unit), sensors, and an RF module. The MCU reads sensor data, such as vibration, temperature, and structural integrity parameters, and transmits the processed data to the onboard reader for real-time monitoring and further analysis.

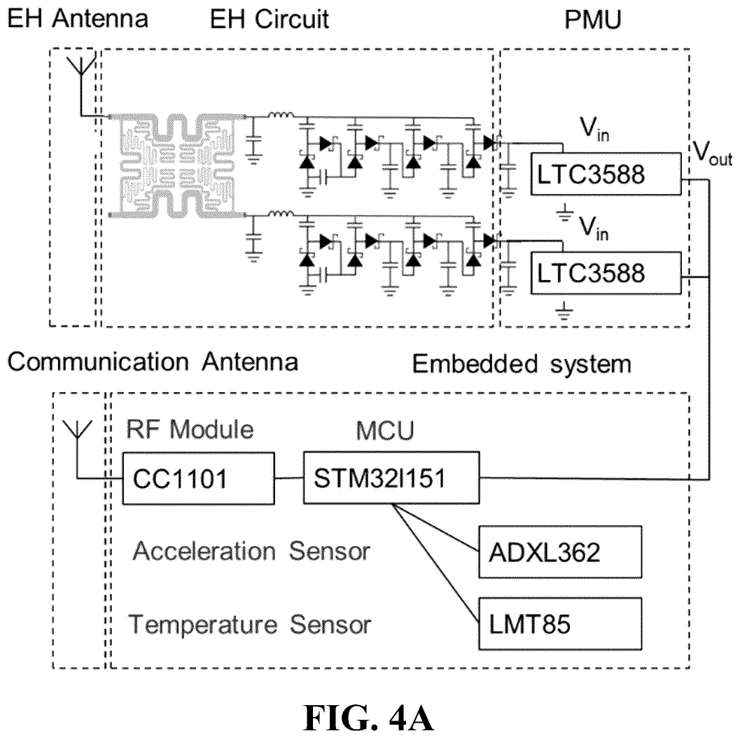

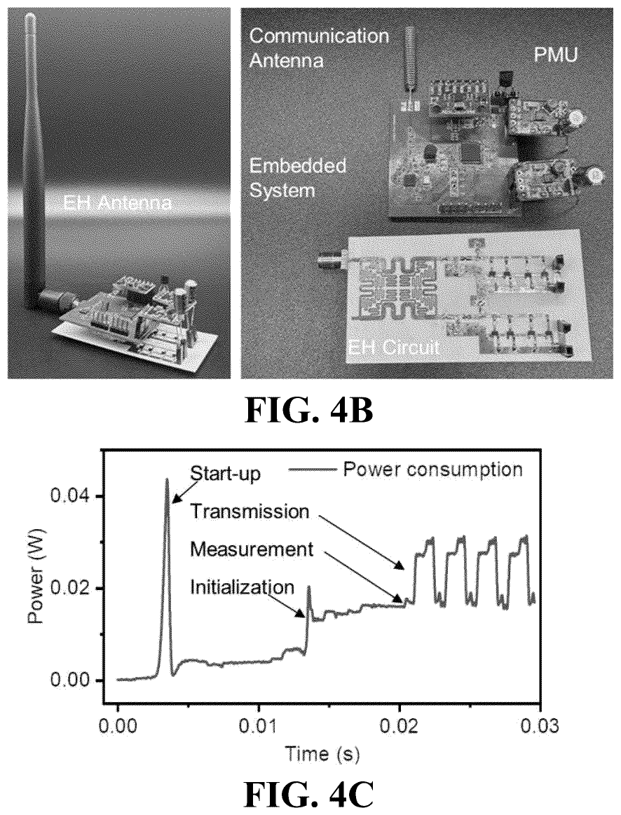

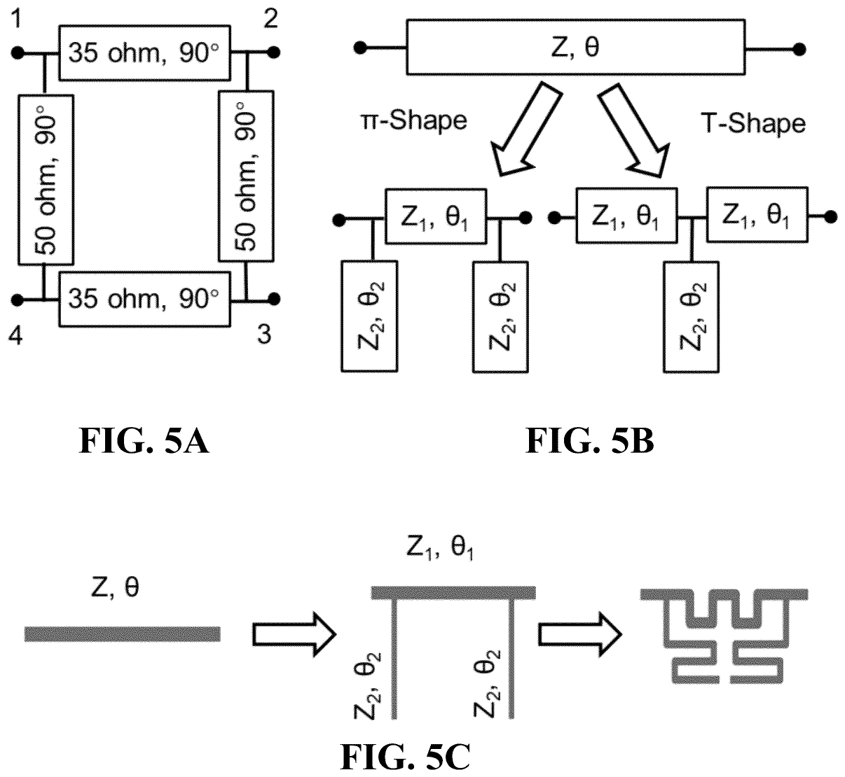

FIG. 4A shows a schematic diagram of a WBMT system architecture according to some embodiments of the present invention. The detailed architecture of the WBMT is provided, which includes an EH antenna, an EH circuit, a PMU, an embedded system, and a communication antenna. The EH circuit converts RF energy into usable DC power. Due to the intermittent nature of harvested RF energy, the system incorporates a nano-power energy harvesting power converter (LTC3588), which features ˜82% efficiency, making it a suitable DC-DC conversion solution. The PMU provides a constant output voltage of 2.5V, enabling the stable operation of the embedded system. Furthermore, to minimize leakage current, the LTC3588 includes an undervoltage lockout detector, which maintains the PMU in a high impedance state during storage capacitor charging.

The embedded system integrates a microcontroller unit (STM32L151), sensors (ADXL362 for acceleration and LMT85 for temperature measurements), and an RF communication module (CC1101). The RF module enables wireless transmission of sensor data to the onboard reader for real-time track condition assessment. To evaluate the system's power consumption, a 2.5Ω resistor can be placed in series, allowing current measurement across the resistor.

Each module is connected via pin headers, as shown in FIG. 4B, which provides a detailed view of the embedded system, power management unit (PMU), energy harvesting (EH) circuit, and communication antenna. FIG. 4C illustrates the measured power consumption of the WBMT. The power profile indicates distinct operational phases. Start-up phase (˜10 ms): The system requires an initial power surge to activate. Initialization phase (˜8 ms): The system stabilizes and prepares for measurement. Measurement and data transmission (˜3 ms): The WBMT collects sensor data and transmits it wirelessly. To minimize response time, the available energy stored in the storage capacitor is only sufficient to support the cold start of the system and the first data transmission. Subsequent transmissions require additional energy harvesting to maintain continuous operation.

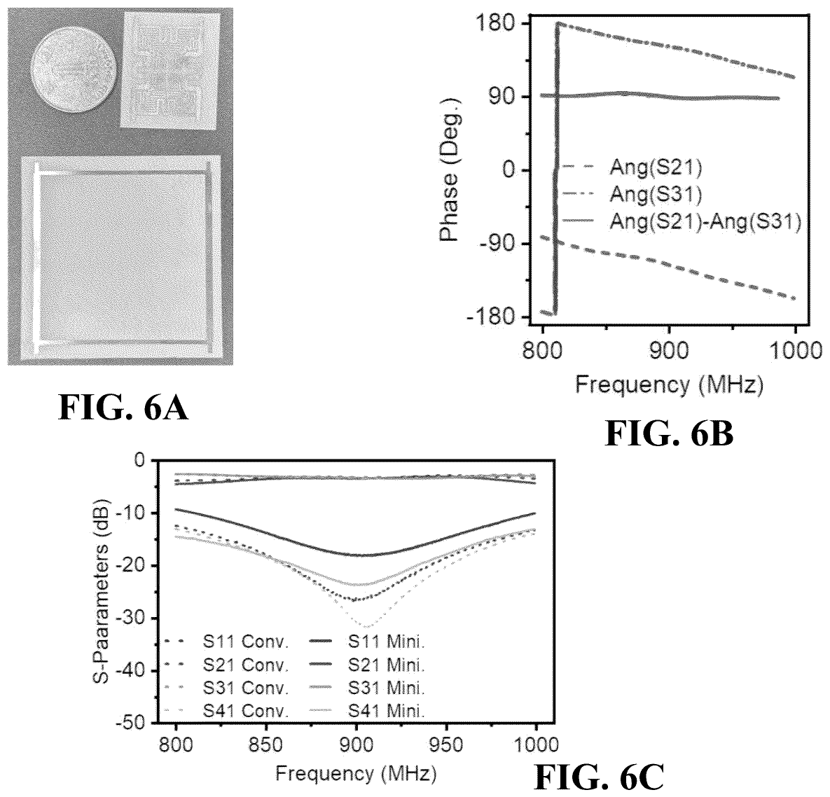

FIGS. 5A, 5B, and 5C illustrate a design scheme of a mini-branch-line coupler (mini-BLC) according to some embodiments of the present disclosure. As shown in FIG. 5A, the conventional branch-line coupler (BLC) consists of four quarter-wavelength transmission line branches with impedances of 50Ω or 35Ω. When power enters Port 1, it is equally split between Port 2 and Port 3, introducing a 90° phase difference between these two output ports. Port 4, known as the isolated port, is theoretically designed to have minimal signal power due to the coupler's inherent isolation property. In an ideal case, all incident power at Port 1 is divided between Ports 2 and 3, with Port 4 receiving negligible or no power.

FIG. 5B presents a transformation of the original transmission line (Z, θ) into its π-shaped and T-shaped equivalent open-stub configurations. Compared to the T-shaped model, the π-shaped model with two shunt open-stubs (Z₂, θ₂) provides greater size reduction, making it a more compact design choice. Furthermore, FIG. 5C illustrates an additional miniaturization step achieved through simulation-based optimization. By folding the open-stub structure, the overall coupler size is further minimized while maintaining its impedance characteristics and performance.

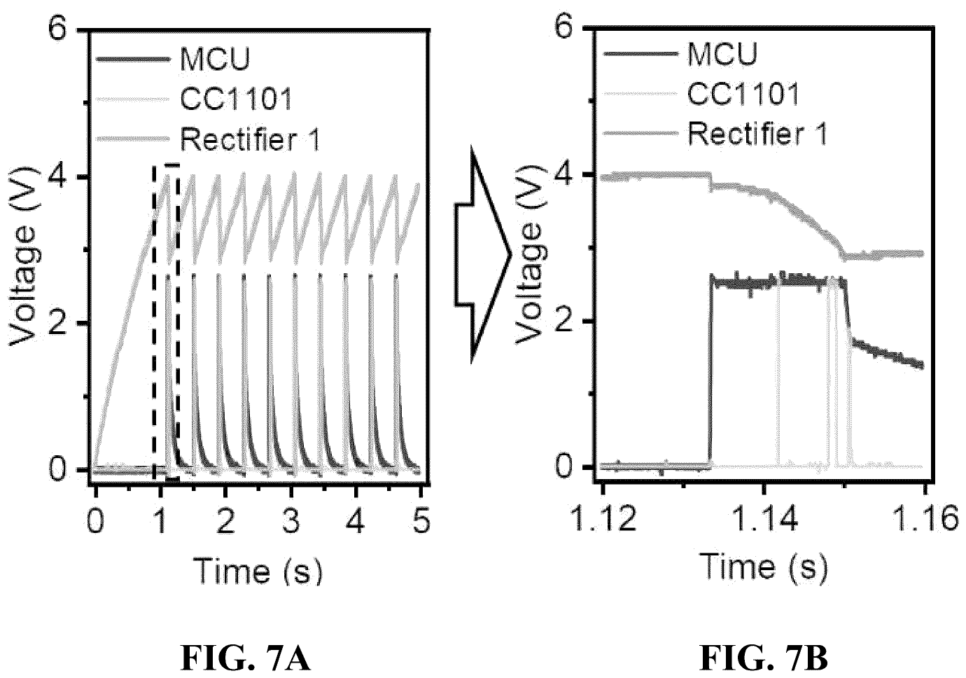

FIGS. 6A, 6B, and 6C compare the performance of the conventional and the proposed mini-BLC. FIG. 6A presents the physical layout of both the conventional BLC and the mini-BLC. The mini-BLC achieves a significantly smaller footprint, with an overall size of 26 mm×21 mm, demonstrating an 80% size reduction compared to the conventional design. FIG. 6B shows the measured phase difference, which remains 90 degrees at 915 MHz. FIG. 6C provides the measured S-parameters, illustrating the electrical performance of both designs. At 915 MHZ, the return loss (S11) and isolation (S41) are below −17 dB and −20 dB, respectively, indicating efficient impedance matching and minimal unwanted signal leakage. Additionally, the measured S21 and S31 are −3.38 dB and −3.45 dB, confirming the effective power division between the output ports. The bandwidths for S11<−15 dB and S41<−15 dB are 2.2% and 20.7%, respectively, suggesting that the mini-BLC exhibits slightly lower insertion loss (<15 dB) compared to the conventional BLC, while maintaining comparable electrical performance. This demonstrates that the miniaturized design effectively optimizes size without significant trade-offs in performance.

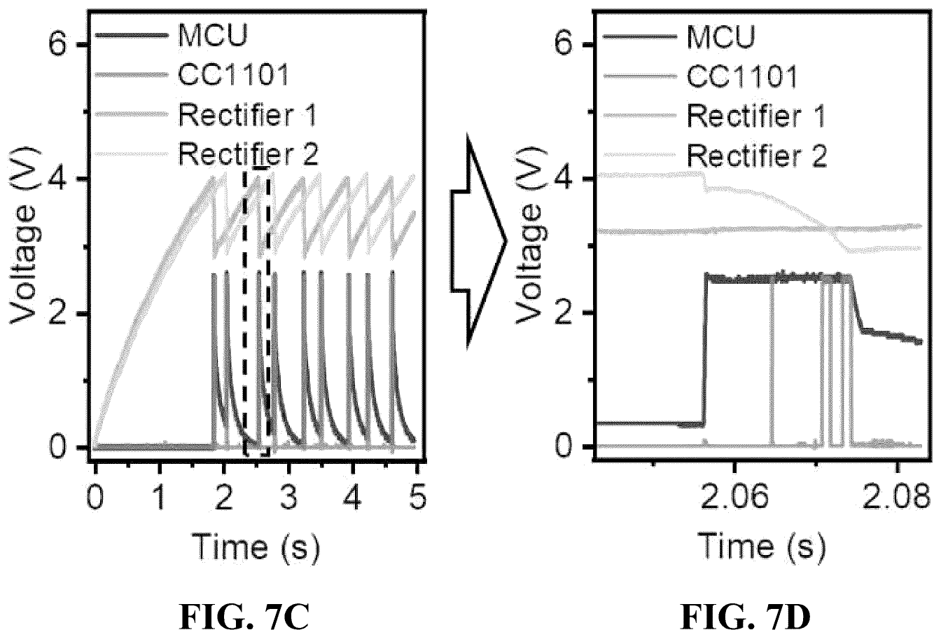

FIGS. 7A, 7B, 7C, 7D present comparison graphs between the proposed energy harvesting scheme and the conventional scheme (4-stage Dickson Voltage Multiplier (DVM) without a Branch-Line Coupler (BLC)). FIG. 7A and FIG. 7B show the voltage variations of the conventional scheme under an input power of 3 dBm. The system requires 1.1 seconds to complete a cold start, after which the output voltage of the rectifier oscillates between 3V and 4V. In each duty cycle, the WBMT initializes, measures, and transmits data. However, due to limited energy storage capacity, the capacitor can only support the transmission of one data frame before the WBMT shuts down, requiring recharging before the next cycle. FIG. 7C and FIG. 7D illustrate the voltage response of the proposed scheme, which incorporates two rectifiers harvesting RF energy simultaneously. However, due to differences in energy loss and impedance mismatch, the rectifiers supply energy alternately to the embedded system. Although the proposed scheme requires a longer start-up time, it benefits from shorter charging intervals due to a slower voltage drop across the capacitive elements. The proposed dual-rectifier system improves efficiency by redistributing the high-efficiency operating region of the rectifiers to a higher input power range, facilitated by the Mini-BLC.

As discussed above, the battery-free and maintenance-free design of the RF-powered railway monitoring system reduces the time and labor costs associated with rail inspection. Additionally, as the system operates without occupying railway tracks, it does not interfere with the normal use of the railway system. Beyond railway monitoring, the design methodology of the RF-powered railway monitoring system can be extended to other asset monitoring applications in inaccessible environments, such as offshore wind turbines, bridges, and tunnels. Furthermore, the WBSTs can be designed using advanced CMOS (complementary metal oxide semiconductor) technology, so as to enable a more compact form factor and higher-resolution measurements, enhancing the precision and efficiency of infrastructure monitoring.

In summary, this invention relates to a method for designing an automatic track monitoring system, referred to as the battery-free and RF-powered railway monitoring system, which monitors rail tracks and detects potential hazards that could pose safety concerns or lead to derailments. The system operates during normal railway service. The system consists of an on-train device and WBSTs. The on-train device utilizes RF energy to wirelessly charge WBSTs. As the train passes, the WBSTs collect data such as track vibration and temperature, which is then transmitted back to the on-train device.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for battery-free and RF-powered railway monitoring, comprising:
a plurality of on-train power generators positioned on a train;
a plurality of wayside battery-free sensing tags (WBSTs) fixedly mounted on rails along a track, wherein the train operates along the track following a predefined route, wherein the on-train power generators are configured to transmit RF energy to the WBSTs for power supply wirelessly when the train passes, such that the WBSTs have no batteries and are powered solely by RF energy emitted by the on-train power generators, and wherein the WBSTs are configured to collect track parameters of the rails along the track to continuously monitor one or more of the track parameters as the train passes;
at least one on-train reader positioned at the train and configured to receive data transmitted from the WBSTs so as to obtain track conditions of the rails beneath the moving train, wherein the on-train reader processes the data and determines whether the track conditions comply with predefined safety thresholds, thereby assessing whether any one or any section of the rails along the track is damaged, and wherein, if an anomaly is detected, the on-train reader is activated to emit signals or send data;
a base station acting as an intermediary communication hub and receiving track data from the on-train reader;
a server storing and organizing the track data from the base station for long-term analysis and railway condition monitoring; and
a control center retrieving data from the server and performing real-time analysis of railway track conditions, wherein, if an abnormality is detected, the control center triggers alerts and notifies an external system.

2. The system according to claim 1, wherein the abnormality includes events regarding loose bolts of the rails, high-temperature deformations of the rails, or cracks of the rails.

3. The system according to claim 1, wherein energy transmission between the on-train power generators and the WBSTs is achieved through RF transmission, and signal communication between the WBSTs and the on-train reader is achieved through RF transmission.

4. The system according to claim 3, wherein frequencies of RF power used for the energy transmission and RF signals used for the signal communication are different.

5. The system according to claim 1, wherein the WBSTs comprises sensors for collecting the track parameters including vibration, temperature, and structural integrity measurements, or combinations thereof.

6. The system according to claim 5, wherein the sensors integrated into the WBSTs comprise accelerometers, temperature sensors, and strain gauges.

7. The system according to claim 6, wherein the data transmitted by the WBSTs comprises position information of the rails, and, once the WBSTs receive the RF energy from the on-train power generators, the WBSTs are activated and wirelessly transmit position information to the on-train reader.

8. The system according to claim 1, wherein the on-train reader is set with the multiple predefined safety thresholds corresponding to various physical parameters, including vibration, temperature, and structural integrity measurements, and wherein, upon receiving the data from the WBSTs, the on-train reader performs an initial assessment by comparing measured values against the predefined safety thresholds, and, if any of monitored parameters in the data exceed an acceptable limit, the on-train reader transmits the data to the base station for further processing and in-depth analysis.

9. The system according to claim 1, wherein the control center generates maintenance plans, which are displayed on a schedule dashboard, utilizing the data collected from the WBSTs.

10. The system according to claim 1, wherein the on-train reader is further configured to receive the track parameters as geographically and temporally discrete information, enabling continuous monitoring of the track between multiple discrete examinations, and wherein the examinations occur at different, non-overlapping time periods or locations.

11. The system according to claim 1, wherein the on-train reader is configured to issue a preliminary alert to the train, displaying a warning signal on a monitor of the train, when the track conditions exceed the predefined safety thresholds.

12. The system according to claim 1, wherein the control center comprises an anomalies trend database storing multiple risky parameter configurations associated with potential traffic accidents, the risky parameters are constructed by various physical measurements, including vibration, temperature, and structural integrity, wherein the control center compares incoming data against high-risk parameter thresholds, and, if detected values closely match conditions defined by the high-risk parameter thresholds, the control center indicates a potential abnormality in the rails.

13. The system according to claim 12, wherein the control center not only detects abnormalities but also determines potential locations of irregular events by using the WBSTs deployed at the rails along the track and equipped with location information.

14. The system according to claim 12, wherein the control center updates the anomalies trend database but does not emit a warning report if a significant change is detected for a certain irregularity from a previous run but does not exceed a safety limit.

15. The system according to claim 12, wherein, upon detection for an irregularity on the track that adversely affects safety of the train, the control center generates an alert signal to notify the presence of the irregularity if the detected irregularity complies with a pre-selected criteria.

16. The system according to claim 12, wherein the control center further comprises a computing device capable of processing acquired data to perform physical parameter calculations and configured to derive physical metrics for relative position and relative motion of the track, and wherein the control center compares at least one of the relative position and the relative motion of the track to a pre-determined safety standard threshold value.

17. The system according to claim 16, wherein the control center utilizes the computing device to detect threshold events occurring in at least one railcar of the train when acceleration or temperature levels exceed a predefined limit, and wherein, upon detection, the computing device determines whether the threshold event is isolated to a single railcar or has also occurred in one or more additional railcars within a specified timeframe.

18. The system according to claim 16, wherein the control center analyzes the timestamps of activation and data transmission of each of the WBSTs and calculates expected time difference between two consecutive WBSTs transmissions based on the train's planned speed.

19. The system according to claim 1, wherein the WBSTs are deployed with a density based on the curvature radius of the track, such that for sharp curves with a smaller radius, a higher density of WBSTs is applied, whereas in gentler curves with a larger radius, a lower density of WBSTs is used.

20. The system according to claim 1, wherein the number of the WBSTs per unit length varies depending on an expected speed of the train in different track sections.
